(19) United States
(12) Patent Application Publication
(10) Pub. No.: US 2020/0184979 A1
(43) Pub. Date: Jun. 11, 2020

(54) SYSTEMS AND METHODS TO DETERMINE THAT A SPEAKER IS HUMAN USING A SIGNAL TO THE SPEAKER

(71) Applicant: Nice Ltd., Ra'anana (IL)

(72) Inventors: Matan KERET, Oulu (FI); Jon A. ARROWOOD, Smyrna, GA (US)

(73) Assignee: Nice Ltd., Ra'anana (IL)

(21) Appl. No.: 16/210,076

(22) Filed: Dec. 5, 2018

(51) Int. Cl. G10L 17/20; G10L 17/18; G10L 17/00

(52) U.S. Cl. CPC G10L 17/20; G10L 17/005; G10L 17/18

(57) ABSTRACT

A system and method of voice authentication of an audio stream represented to be the spoken voice of a person, may include receiving via a device such as telephony device a voice stream or voice recording represented to be that of a person speaking, providing an interfering or interrupting audio signal to the device, and using information regarding the interfering audio signal, determining if the voice stream indicates a reaction to the audio output. In such a manner it may be determined if the spoken voice is that of a real, live, person, speaking in real-time, or that of a device or person attempting to imitate a person (e.g. using a recording).

### FIELD OF THE INVENTION

The invention relates generally to automatic authentication of a speaker, and in particular, providing a signal or input to determine whether or not the speaker is an actual human speaker.

### BACKGROUND OF THE INVENTION

Companies and organizations such as call centers try to authenticate people communicating with the organizations—to verify that the person communicating is who they say they are, and not an imposter or fraudster. Technology exists to authenticate people using or aided by voice biometrics. For example, in an interactive voice response (IVR) system, a caller can be prompted to speak a phrase, the received audio signal from the caller speaking the phrase can be compared to an existing voice biometrics model for the caller, and if there is a match, authentication is successful and the call can continue.

However, self-service or automated voice biometrics systems can be fooled. One method of fooling automated systems into positively authenticating someone who is not the actual person is to play pre-recorded audio collected by a fraudster. For example the fraudster may know the passphrase at a company is always a standard phrase, e.g. “my voice is my password”, and the fraudster calls the actual person and tricks him into saying these words, e.g. by pretending to be a survey company. The resulting audio stream is recorded, and possibly edited (e.g. clipped and stitched) and may be used to fool an IVR system into determining the person calling is the actual person.

Fraudsters may use synthetic speech systems which can produce real-time speech that sounds like a specific person, in a text-to-speech (TTS) process. Such a system may be trained using a reasonable amount of audio from the real speaker (e.g. 5-60 minutes). Such systems include the Adobe Voco system, Baidu's Deep Speech system, and others. Voice biometrics systems are being faced with machine learning text-to-speech models that are easily trained to sound like anyone. Such systems have already been shown to fool voice biometrics engines over 90% of the time.

### SUMMARY OF THE INVENTION

A system and method of voice authentication of an audio stream represented to be the spoken voice of a person, may include receiving via a device such as telephony device a voice stream or voice recording represented to be that of a person speaking, providing an interfering or interrupting audio signal to the device, and using information regarding the interfering audio signal, determining if the voice stream indicates a reaction to the audio output. In such a manner it may be determined if the spoken voice is that of a real, live, person, speaking in real-time, or that of a device or person attempting to imitate a person (e.g. using a recording).

### BRIEF DESCRIPTION OF THE DRAWINGS

Non-limiting examples of embodiments of the disclosure are described below with reference to figures attached hereto that are listed following this paragraph. Dimensions of features shown in the figures are chosen for convenience and clarity of presentation and are not necessarily shown to scale.

The subject matter regarded as the invention is particularly pointed out and distinctly claimed in the concluding portion of the specification. The invention, however, both as to organization and method of operation, together with objects, features and advantages thereof, can be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 is a block diagram of a system for voice authentication according to an embodiment of the present invention.

FIG. 2 is a high-level block diagram of an exemplary computing device which may be used with embodiments of the present invention.

FIG. 3 is a flowchart of a method according to embodiments of the present invention.

FIG. 4 is a flowchart of a method according to embodiments of the present invention.

FIG. 5A is a graph showing the result of an example use of a method according to embodiments of the present invention.

FIG. 5B is a graph showing the result of an example use of a method according to embodiments of the present invention.

FIG. 5C is a graph showing the result of an example use of a method according to embodiments of the present invention.

It will be appreciated that for simplicity and clarity of illustration, elements shown in the figures have not necessarily been drawn accurately or to scale. For example, the dimensions of some of the elements can be exaggerated relative to other elements for clarity, or several physical components can be included in one functional block or element.

### DETAILED DESCRIPTION

In the following detailed description, numerous specific details are set forth in order to provide a thorough understanding of the invention. However, it will be understood by those skilled in the art that the present invention can be practiced without these specific details. In other instances, well-known methods, procedures, and components, modules, units and/or circuits have not been described in detail so as not to obscure the invention.

Embodiments of the present invention may aid in voice authentication or verification of a user. Prompts of the authentication process may be altered to assist in detection of non-human callers.

Authentication or verification may be the process of confirming the identity of a person. In the context of audio telephony this is often done using, all or in part, the voice pattern or voice biometrics of a person. For example, a person may call or otherwise contact a company and that person may be identified, or preliminarily identified, by their telephone number automatically (e.g., using caller identification (ID) or automatic number identification (ANI)), or by information provided by the user such as name, customer ID, account number, etc. The company may want to authenticate that person, to determine the person speaking or calling does in fact correspond to the initial identification. Authentication may be performed by the user providing a password, by the user answering a question the answer to which is likely only known by the actual person, by voice biometric identification, and/or other methods.

Fraudsters may try to “authenticate” themselves, purporting to be a certain person, using the pre-recorded voice of the actual person associated with the ID or account, or automatic or synthetic (e.g. TTS) voice generation using a process trained to sound like that person. This may occur more easily with IVR systems, which allow computers to interact with humans through the use of voice and dual-tone multi-frequency signaling (DTMF, or touch tone) tones input via a keypad: in such systems, a human agent or representative may not speak to the alleged customer, at least during authentication. IVR may allow customers to interact with a company's computer systems (e.g. sales, authentication, account maintenance or information) via a telephone keypad or by speech recognition. IVR systems can respond with pre-recorded or dynamically generated audio.

Typically, acoustics and speech analysis techniques are used for speech-based authentication. Speaker authentication may require prior enrollment during which the speaker's voice is recorded and features are extracted to form a voice print, template, or model. During authentication or verification the audio stream or a recording, or a speech sample from the person is compared against a previously created voice print. In a text-dependent system, the response or passphrase a user speaks to be authenticated must be the same for enrollment and authentication. Typically, a “response” is a specific sequence of text, phrase, etc. that a user is instructed to speak (e.g. “My name is XXXX” where XXXX is the actual user name; “The Pacific Ocean is large”. “I am the strongest oak in the forest”, etc.). Typically the user is prompted with a prompt: e.g. the IVR system outputs a prompt (e.g. “Repeat ‘the sky is blue’”) and the caller or user responds to the prompt with a response. e.g. by stating “the sky is blue”. Prompts may be standardized, in that all users may be asked to speak the same response, or have prompts chosen from the same set of prompts, but prompts may not be standardized or identical across users. In a text-independent system the text spoken during enrollment and test can be different. Speech authentication may use for example frequency estimation, hidden Markov models, Gaussian mixture models, pattern matching algorithms, neural networks, matrix representation, Vector Quantization, and decision trees. Typically spectral features are used in representing speaker characteristics. However, other methods and features may be used for speech authentication.

In various embodiments of the invention, an authentication attempt may be made where a voice received via a telephone call or other interaction may be alleged to be both that of a real speaking person (as opposed to a recording of a person, or a computer or other simulation of a person's voice), and in fact a specific person. A fraudster may be a human using or operating a recording of the person they profess to be, or operating a TTS process imitating the person they profess to be. A person or process communicating e.g. using a telephony device (e.g. a telephone, voice-over-IP (VOIP) process, an app on a smartphone, videoconference system, etc.) may attempt to be authenticated using an allegedly “live”, real-time or contemporaneous spoken voice. The process may start via typical known voice authentication processes: the person may be asked to speak a response or phrase, e.g. “I am the strongest oak in the forest”, or if text-independent, may simply be asked to speak. While the person is speaking, e.g. during the response, an interfering audio signal may be provided to the person telephony device. Typically, the interfering signal is one or more of a surprise, unannounced, and differing for different callers. For example, a beep or tone, or a simulation of telephony line noise (e.g. white noise or other noise), or static, may be presented or sounded to the speaker during the voicing of the pass phrase. A live (live in the sense of speaking at that moment, e.g. in real-time) or real person will typically have a reaction to this: a stutter, a pause, a repeat of a word or part of a word, the raising of the volume of the voice, dysfluency etc. A computer-generated voice, or an audio recording of a voice, typically does not react in this way.

While in some embodiments an audio interfering signal is provided, in other embodiments the signal need not be audio. E.g. a visual signal may be provided. A user may view a mobile device to read a prompt phrase and repeat the phrase, the interruption could be the mobile device screen momentarily being scrambled.

Using the reaction, it can be determined if the person is an actual person, or not. Information regarding the interfering audio signal may be used to determine if the voice stream indicates a reaction to the audio output, and thus the likelihood of a real person: typically a process according to embodiments of the present invention takes as input both an audio stream or recording of the “person's” speaking of the pass-phrase or response to the prompt, and in addition information describing the interfering signal and its timing, so that it can be determined where in the audio stream the reaction can be expected to occur. If the voice stream indicates a reaction to the interfering audio signal, it may be determined that the audio stream is an audio stream of a person speaking live, and if not it may be determined that the audio stream is not a person speaking live. The “proper” reaction to the interruption or audio injection, if detected, may be used to determine whether or not the person is real or live, alone, or in conjunction with other evidence: e.g. in some embodiments the reaction to the interruption may be only part of the evidence or decision regarding whether or not the person is genuine. Other evidence or “liveness detection” methods may include for example presenting a dynamic passphrase to the caller and then verifying that the called quoted or repeated the expected words, and playback detection methods, such as detecting if the sound quality is reduced due to a codec used for a pre-recorded voice. If the voice stream indicates a reaction to the interfering audio signal, and it is determined that the audio stream is an audio stream of a person speaking live the person may be authenticated; if not the process may decide to not authenticate the person, or to not go through an authentication process. Thus the interruption-mechanism may be used to determine that the speaker is a human, and based on the output of this (and possibly other conditions) an authentication process may take place or it may be decided that an authentication process should not take place. Alternatively, the output of the interruption test may be part of the evidence input to an authentication process.

Humans change their speech relative to their environment. In noisy environments, for example, people may speak with the “Lombard Effect”, speaking more loudly, increasing the pitch, shifting energy from low to high frequency bands, increase the relative durations of vowels, etc., in order to increase the intelligibility to others in a loud environment. Humans may hesitate when speaking upon the occurrence of a loud interrupting sound. For example, when someone else in the room coughs, the person who is currently speaking may insert a short pause in their speech to shift information in time with the goal of increasing intelligibility. If human speech production and hearing systems are considered to be a communication channel, the systems adapt in both time and frequency to the environment's time-varying noise and distortion characteristics to optimize the information carrying capability. These changes may be nearly involuntary, as they have both evolved, and have been trained over a lifetime of real-world experience.

In some embodiments, interruptions are not sent to every caller, as the interruptions may result in a negative experience for callers.

Embodiments of the invention may use these involuntary changes in human speech in order to detect non-human speech systems. For example, an embodiment may prompt the caller to say a phrase, and in the middle of the speech, a loud tone is played, interrupting them. A human will alter their speech pattern to account for this interrupting tone. And by detecting this alteration, which presumably will not occur in pre-recorded or synthetic systems, the “human-ness” of the remote caller can be verified.

The output may be a determination, or a likelihood, rating or score, as to whether or not the person is likely a real person, or whether or not the person is suspected as being a simulated person or recording (e.g. a yes/no determination that the person is real or not real, a percentage likelihood that the person is real, etc.). This output may be used to determine whether or not an authentication process takes place, or may be used in authenticating the person: e.g. the authentication process may proceed regardless of the determination of whether or not the person is a live human speaking at the time of the authentication (e.g. contemporaneous), but the authentication process may take into account information on whether or not it is determined that the speaker is a live human.

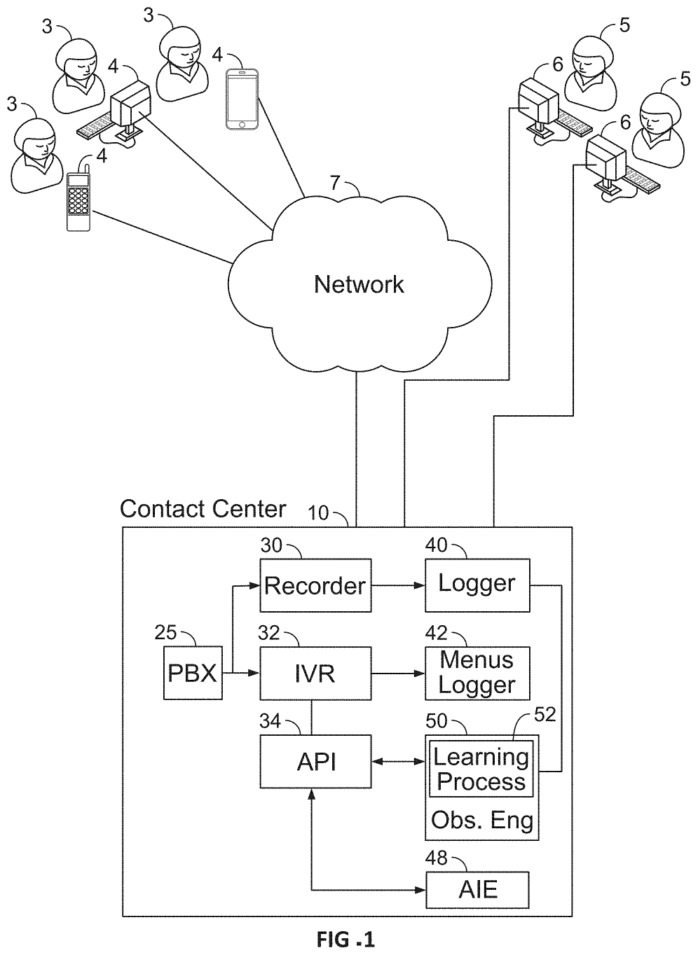

FIG. 1 is a block diagram of a system for authenticating users according to an embodiment of the invention. While FIG. 1 shows a system authenticating callers at a contact center, other entities may use methods as described herein and equipment as described in FIG. 1. Contact center 10 may be for example maintained or operated by a company (e.g. a bank, a store, an online retailer), government or other organization. Embodiments of the invention may be used at any organization, company, etc. wishing to determine if a caller is in fact a human.

Customers, callers or people 3 may communicate with contact center 10 via for example telephone calls, VOIP calls. IVR interactions, etc. Agents 5 may participate in some portion of such calls via contact center 10. Calls may be routed for example by PBX (private branch exchange) 25 or other equipment to relevant systems, such as an interactive voice response (IVR) block or processor 32, voice interactions block or recorder 30 and menus logger 42. Callers or people 3 may operate user equipment 4 (e.g. telephony devices) to communicate with IVR block 32 and/or agents 5 via contact center 10; and agents 5 may operate agent terminals 6 for that communication and other purposes. In some interactions or portions of interactions between callers 3 and contact center 10, callers 3 may communicate via IVR (with IVR block 32) only, not speaking to a “live” agent 5, inputting information or making choices using touch-tone entry or voice response entry, and hearing audio voice generated by IVR block 32. While IVR is described as being involved with embodiments of the invention, in some embodiments IVR and other systems shown may be omitted.

Interaction data may be stored, e.g., in files and/or databases: for example recorder 30 in conjunction with logger 40, and menus logger 42, may record and store information related to calls and interactions, such as the content or substance of interactions (e.g. recordings and/or transcripts of telephone calls) and metadata (e.g. telephone numbers used, customer identification (ID), etc.).

One or more networks 7 may connect equipment or entities not physically co-located. For example network(s) 7 may connect user equipment 4 to contact center 10. Network(s) 7 may include for example telephone networks, the Internet, or other networks.

Contact center 10 presented in FIG. 1 is not limiting and may include any blocks and infrastructure needed to handle voice, text (SMS (short message service), WhatsApp messages, chats, etc.) video and any type of interaction with callers.

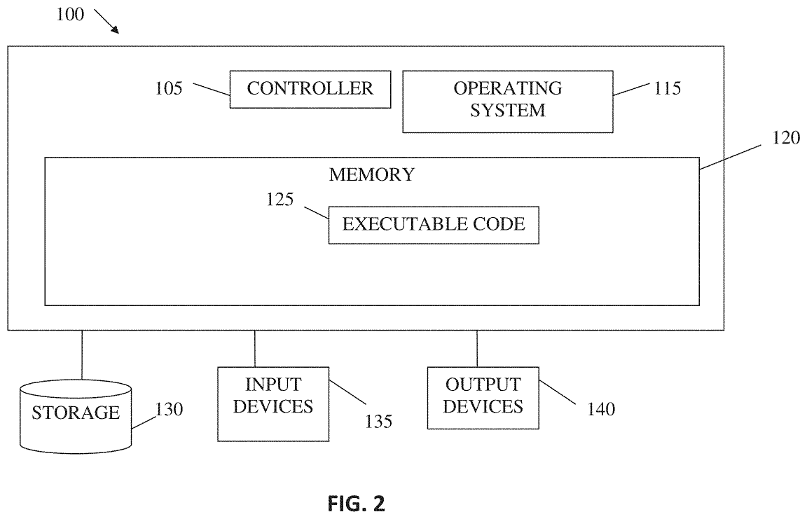

User equipment 5 and agent terminals 6 may include computing, telephony or telecommunications devices such as personal computers or other desktop computers, conventional telephones, cellular telephones, portable or tablet computers, smart or dumb terminals, etc., and may include some or all of the components such as a processor shown in FIG. 2.

Connect application program interface (API) 34 may be a layer used to enable modules such as IVR 32 to interact with modules such as audio injection engine 48 and observation engine 50 e.g. via function calls, and to pass information from pre-existing components, e.g. IVR 32, or a customer relations management (CRM) system to, and receive information from, engines 48 and 50. Protocols used may include the simple object access protocol (SOAP). Hypertext Transfer Protocol (HTTP) and transmission control protocol (TCP), or other suitable protocols. API 34 is shown in FIG. 1 separately from audio injection engine 48 and observation engine 50, but may be part of these modules. Audio injection engine 48 may accept requests from IVR block 32 or other entities for audio to inject as interruptions. For example IVR block 32 may send or make a “CreateInterruption” call using API 34, to send a request to audio injection engine 48 which may create or provide an interruption, possibly along with other information such as the text which the person will speak as the response or phrase (prompt text may also be provided by a requesting entity to audio injection engine 48, which may tailor the interruption appropriately). Audio injection engine 48 may use processes as discussed herein to create an appropriate audio interruption, and send back audio used for an interruption possibly in conjunction with a time (e.g. in milliseconds, measured from the start of the caller response) to send the interruption. The generated interruption audio may be in any suitable format, such as a byte array, but in some embodiments it may be transformed into a string representation for passing it over HTTP\S (secure HTTP). The response from audio injection engine 48 to a call such as CreateInterruption may be for example an audio interruption and a time delay indicating when within the response or user spoken phrase to send the interruption. The audio interruptions may be varied by the audio injection engine 48 e.g. by type, timing, duration, frequency, or other factors.

IVR block 32 may request (e.g. using a verbal request that such systems may generate) that the caller speak or respond to the prompt. IVR block 32 may provide the interruption to the caller at the specified time, and IVR block 32 may record the response or phrase spoken by the caller. Typically the recorded response of the caller speaking lacks the audio of the interruption, but in some embodiments the user response may include audio of the interruption. IVR block 32 may provide the recorded block spoken by the caller, e.g. a voice stream, along with other data such as the time within the response (e.g. from the beginning of the response) the interruption was sent, to caller observation engine 50 (e.g. using an API call such as AnalyzeInterruption), which may determine, as discussed elsewhere, if the caller is a real, live-speaking (e.g. speaking live, e.g. at the time of the analysis), human, or the likelihood or rating that the caller is a real, live-speaking human.

One tool an example caller observation engine 50 may use is a learning-trained process 52, however other analysis tools may be used. Learning-trained process 52 may be a data-trained deep-learning process (e.g. a neural network) trained with samples of interrupted and non-interrupted speech to detect, e.g. at runtime, whether a speaker is a real person or not. In some embodiments, if a reaction to interrupted speech is detected in a spoken response but it does not occur at the expected time, corresponding to the time of the interruption within the response adjusted for telephony latency or delays, it may be determined that the “speaker” is likely not a live human. While, as with other functionality described herein, it is described that certain blocks perform certain functionality, in other embodiments the functionality may be arranged differently. An API need not be used.

FIG. 2 shows a high-level block diagram of an exemplary computing device which may be used with embodiments of the present invention. Computing device 100 may include a controller or processor 105 that may be, for example, a central processing unit processor (CPU), a chip or any suitable computing or computational device, an operating system 115, a memory 120, a storage 130, input devices 135 and output devices 140. Each of modules and equipment such as contact center 10. PBX 25, IVR block 32, voice interactions block or recorder 30, menus logger 42, connect API 34, audio injection engine 48, caller observation engine 50, learning-trained process 52, user equipment 4, and agent terminals 6 may be or include a computing device such as included in FIG. 2, although various units among these entities may be combined into one computing device.

Operating system 115 may be or may include any code segment designed and/or configured to perform tasks involving coordination, scheduling, arbitration, supervising, controlling or otherwise managing operation of computing device 100, for example, scheduling execution of programs. Memory 120 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 120 may be or may include a plurality of, possibly different memory units. Memory 120 may store for example, instructions to carry out a method (e.g. code 125), and/or data such as user responses, interruptions, etc.

Executable code 125 may be any executable code, e.g., an application, a program, a process, task or script. Executable code 125 may be executed by controller 105 possibly under control of operating system 115. For example, executable code 125 may be an application which generates or sends an interrupting signal or audio injection to a caller and/or analyzes that signal to determine if the caller is a human, authenticates a caller, operates an IVR system, etc., according to embodiments of the present invention. In some embodiments, more than one computing device 100 or components of device 100 may be used for multiple functions described herein. For the various modules and functions described herein, one or more computing devices 100 or components of computing device 100 may be used. Devices that include components similar or different to those included in computing device 100 may be used, and may be connected to a network and used as a system. One or more processor(s) 105 may be configured to carry out embodiments of the present invention by for example executing software or code. Storage 130 may be or may include, for example, a hard disk drive, a floppy disk drive, a Compact Disk (CD) drive, a CD-Recordable (CD-R) drive, a universal serial bus (USB) device or other suitable removable and/or fixed storage unit. Interaction and journey data Content may be stored in a storage 130 and may be loaded from storage 130 into a memory 120 where it may be processed by controller 105. In some embodiments, some of the components shown in FIG. 2 may be omitted.

Input devices 135 may be or may include a mouse, a keyboard, a touch screen or pad or any suitable input device. It will be recognized that any suitable number of input devices may be operatively connected to computing device 100 as shown by block 135. Output devices 140 may include one or more displays, speakers and/or any other suitable output devices. It will be recognized that any suitable number of output devices may be operatively connected to computing device 100 as shown by block 140. Any applicable input/output (I/O) devices may be connected to computing device 100, for example, a wired or wireless network interface card (NIC), a modem, printer or facsimile machine, a universal serial bus (USB) device or external hard drive may be included in input devices 135 and/or output devices 140.

Embodiments of the invention may include one or more article(s) (e.g. memory 120 or storage 130) such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein.

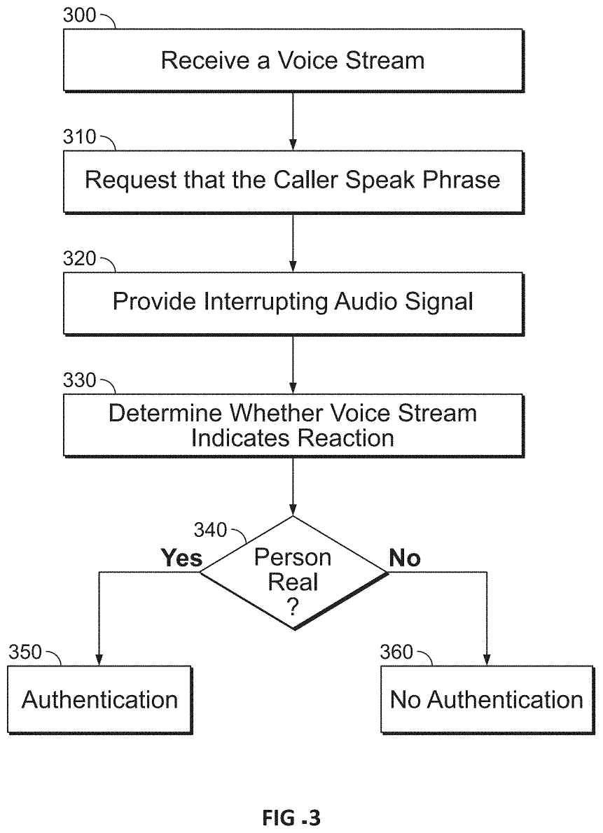

FIG. 3 is a flowchart of a method according to embodiments of the present invention. While in one embodiment the operations of FIG. 3 are carried out using systems as shown in FIGS. 1 and 2, in other embodiments other systems and equipment can be used.

In operation 300, a system such as contact center 10 or IVR block 32, or other equipment, may receive via a telephony device such as a telephone, computer with telephony capability, VOIP device, etc., a voice stream represented to be that of a person speaking, or speaking “live” (e.g. at that time). For example, a person or automated process may call an organization and identify themselves or itself as a certain person (e.g., speaking or entering via touch-tone an ID, account number, name, etc.). A stream comprising audio of a voice may thus be received.

In operation 310, the system receiving a call may request that the caller speak in order to be authenticated as being the person as which the person self-identified. Typically, the system receiving the call may provide a phrase for the person to speak, but in some embodiments the system may simply ask the person to speak, or may use speech that the person has used while responding to IVR prompts. In different embodiments, speech collected from the caller can come from a direct prompt (e.g. “to verify your identity, please say the following phrase . . . ”) or from passively observing answers to other questions in a process such as an IVR process (e.g. “please say your account number” or “in a few words, please state the reason for your call, so we can route you to the proper agent . . . ”).

In operation 320, while the person (or “person” in the case of an attempt to fool the authentication system using recorded voice, or artificially generated voice) is speaking, e.g. during the receipt of the audio stream, the response or text sample, the system receiving a call may provide or send an interfering or interrupting audio signal, or transmit interruption audio, to the telephony device so that the caller will hear the signal. The person's response may be recorded or streamed for example as a recorded or streamed voice stream. The audio may be sent via the audio channel from the system (e.g. the IVR) back to the caller, as with a typical telephony call the audio channel is two-way. For example, the audio injection signal may be a beep, noise, tone, simulation of telephony line noise or error, etc. Another manner of audio injection or interruption may include speech in a language other than that being spoken by the user, or gibberish. The signal may be sent at a certain calculated, randomized or pre-determined time within the time the person is speaking the response. Typically the interrupting signal is not announced to the user in advance, and may be presented as an accident or mistake: thus the user is not prepared for the signal and acts naturally.

In operation 330, using information regarding the interfering audio signal, it may be determined whether or not the voice stream indicates a reaction to the audio output, or a reaction typical of that of a real human. Other similar determinations or calculations may be made, such as the likelihood, or a rating that the speaker is an actual live human. Such a detection may be performed for example by caller observation engine 50, or by another module or process. For example, the audio stream of the person “speaking” may be analyzed to determine whether or not the audio of the voice includes a reaction to the interruption audio.

The reaction may be involuntary or unconscious, or voluntary, e.g. a person may raise the volume of their voice if noise appears, or repeat a word or part of a word, or pause, or produce a dysfluency, if it appears the telephony line was disturbed. For example, a process such as caller observation engine 50 may accept a recording of the person speaking the response or phrase, or the person speaking information which is used for authentication or other information (e.g. responses to IVR prompts, the person's name or ID or account number, etc.), and other data such as the specific interruption signal, or parameters describing the signal (e.g. type of signal, frequency parameters, length of the signal, etc.), the time within the response that the interruption was sent, the line delay or expected line delay (e.g. the time shift inherent in telephony specific to a certain application or system), etc. In some embodiments determining if a voice stream indicates a reaction to the audio output or does not indicate a reaction includes relating the time that the interfering audio signal is provided during the voice stream to the time the reaction during the voice stream occurs. Recordings of the person speaking may be in any suitable format, such as a byte array, a Waveform Audio File Format (.WAV) file, pulse-coded modulation (PCM), the G729 format, the G711 format, a universal naming convention (UNC) path, and a stream for example if a cloud solution is used (e.g. the Kinesis Video Stream of the AWS service). In the case the caller audio is to be received from an external system (such as an external IVR system), a link to the location of the voice recording may be used. In some embodiments recordings may be transformed into a string representation for passing over HTTP\S.

The process may return an indication if the voice stream is that of a real person speaking “live” or if the voice stream is not (e.g. yes/no), or a rating or probability that the voice stream is that of a real person, or a rating or probability that the voice stream is not that of a real person. In one embodiment, based on the voice or audio including a reaction, a rating, score (e.g. of “livelihood”) or likelihood may be determined indicating that the stream is of a person speaking contemporaneously. Further, a rating, score or likelihood may be determined indicating the likelihood that the voice or audio includes a reaction, which may in turn be an indication that the stream is of a person speaking contemporaneously.

In operation 340, if the person speaking is a real person, or if the likelihood that the person speaking is real is higher than a threshold (e.g. if the voice stream indicates a reaction to the interfering audio signal), the process may proceed to operation 350 (authentication). If the person speaking is not a real person, or if the likelihood that the person speaking is real is not higher than a threshold (e.g. if the voice stream indicates no reaction, or does not indicate a reaction, to the interfering audio signal), the process may proceed to operation 360 (no authentication). In some embodiments, if it is determined that the person is not real, actions unrelated to authentication may take place, e.g. a fraud alert may be sent to the relevant entities. Thus if the voice stream indicates a reaction to the interfering audio signal, it may be determined that the audio stream is an audio stream of a person speaking live; and if the voice stream does not indicate a reaction to the interfering audio signal, it may be determined that the audio stream is not a person speaking live.

In some embodiments, whether or not it is determined that the person is real, or the rating or likelihood, may be only one factor or item of evidence determining if the authentication process proceeds, or if the person is authenticated, and thus operation 340 may not be a simple yes/no decision based only on assessment of whether or not the person is real.

In operation 350, an authentication process is performed. e.g. the person's self-presented identification is used in combination with other information to determine if the person is who they assert they are. This may be performed using conventional methods. For example, the person who is confirmed as “likely” a live human or a live human may enter a password. Other authentication methods may be used: for example IVR block or processor 32, for example, may determine whether or not a spoken response or phrase from the person matches a voiceprint, or may compare a phrase spoken by a person to be authenticated to an existing voice biometrics model. Systems that may be used for voice biometric authentication include those supplied by NICE, Ltd., of Israel. After authentication, if the authentication is successful, depending on the context and application, the person may for example be allowed access to accounts, may be able to purchase items, etc.

In operation 360, no authentication process is performed, e.g. the person's self-presented identification is not used in combination with other information to determine if the person is who they assert they are. In some embodiments no authentication process being performed may have the same effect as an unsuccessful authentication: e.g. no access to accounts. In some embodiments no authentication process being performed may have an effect different from or beyond an unsuccessful authentication: e.g. a fraud alert may be sent to the relevant entities.

The operations of FIG. 3 are examples only, and different operations may occur in different embodiments.

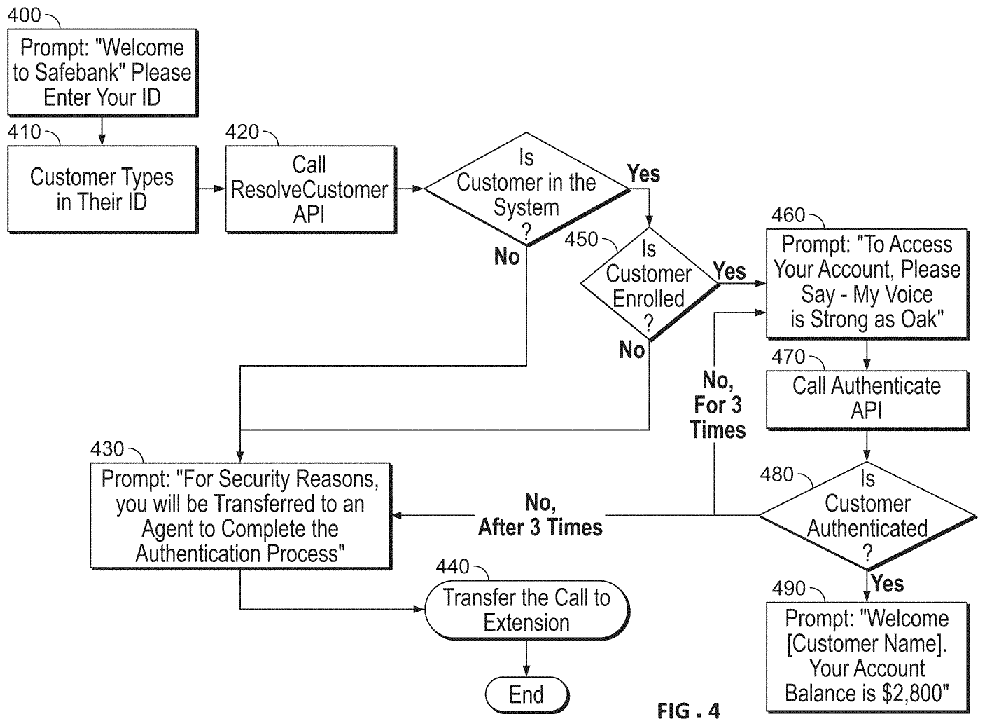

FIG. 4 is a flowchart of a method according to embodiments of the present invention. While in one embodiment the operations of FIG. 4 are carried out using systems as shown in FIGS. 1 and 2, in other embodiments other systems and equipment can be used. FIG. 4 may use or be used with embodiments of the present invention.

In operation 400 a user contacting or being contacted by an organization may be asked for their identification, and in operation 410, the user may enter their identification. Identification may be provided in other ways, such as automatically via ANI or caller ID, or by a user speaking in their name or account number. For example, account number or name can be inferred from ANI, spoken as a voice response, entered via touch-tone or inferred from other information.

In operation 420, a process may preliminarily identify, based on information provided in operation 400, the customer. Such an identification may or may not result in a name or other identifying information: for example operation 420 may determine only an account number. The identification may be considered preliminary because at this point it is not confirmed that the person is an actual person as opposed to a recording or automated process, and it is not confirmed that the person is who the person self-identifies as.

If the user or customer not known to the entity (e.g. not registered as a customer with an organization), the process may proceed to operation 430. In operation 430, the user may be told that they will need to speak with a live agent. In operation 440, a live customer agent may speak with the user or customer to handle exceptions or problems, for example to determine if a mistake has been made and the user is actually enrolled, to determine if a mistake has been made and the person is actually a human or is actually the person they claim to be, to enroll the user, to ask more questions to determine if authentication can be achieved, or for other reasons. In one example, for enrollment, speech samples are collected from the user, and abstracted into for example a voiceprint. Other enrollment methods may be used.

If the user or customer is known to the entity (e.g. registered as a customer), the process may proceed to operation 450. In operation 450, it may be determined if the person is enrolled with the voice-recognition capability of the relevant organization, and if not, the process may proceed to operation 430. If the person is enrolled, the process may proceed to operation 460.

In operation 460, the user may be asked to speak a certain phrase or response.

In operation 470, the customer may be authenticated. This may involve first determining if the user is a live person, as opposed to a recording or voice-production process, or as opposed to a person who is not the user operating a recording to a voice-production process. Thus in some embodiments of the invention certain processes identify whether or not the speaker is a person—any person—speaking contemporaneously with the authentication process (as opposed to being recorded), e.g. caller observation engine 50; and certain processes determine if the speaker is a certain person. If the person is a live person or is likely to be so, the person may be authenticated: for example a recording of the person speaking a response may be matched to a voiceprint. These operations may be done for example by using operations such as some of those shown in FIG. 3. While authentication via voice enrollment and analysis is described, in other embodiments other methods of authentication may be used, such as password authentication.

In operation 480, if authentication was not successful (e.g. the person was determined not to be a real human, and/or the person's spoken response or phrase did not match the speech pattern enrolled with the system), in one embodiment the person may be given another chance, for example up to a limit of three times, and the process may iterate back to operation 460. If authentication is not successful for a certain number of times, e.g. three times, the process may proceed to a live agent in operation 430. If authentication is successful, the process may proceed to operation 490, where the call can continue and/or customer may have access to the relevant system.

The operations of FIG. 4, and the example processes shown in FIG. 4 itself, are examples only, and different operations and different specific examples may occur in different embodiments.

Production of audio interruption signals may for example be performed by an IVR or other system calling, e.g. via an API, a process such as audio injection engine 48, although the organization of the system, in terms of which module performs which function, may differ in different embodiments. For example, one unified module may perform user authentication and also verification that a speaker is a live human. A process generating speaker interrupts may receive data such as the text which the person will speak as the response; this text may enable the process to decide where in the response to place the interruption, and thus what delay or time to return or provide as the point within the spoken response to place the interruption. For example, an interruption placed too close to the beginning or end of the response may not induce a reaction in a speaker. A process generating interrupts may use learning or be programmed according to machine learning or other experience to calculate the time for the response that produces the best detection rates. A process generating interrupts may vary the type and characteristics of the interrupt, possibly randomly. For example, on each request for an interrupting signal, a different type or category (e.g. beep, line static, noise, playing back user voice (echo), etc.) may be selected or chosen (e.g. randomly, or in another manner), and/or different qualities such as length or duration of the interruption, audio frequency of the interruption, peak volume or peak of other value during the interruption, and the timing of the interruption within the user response. For example, recordings of specific beep(s), line static sequence(s), etc. may be chosen, and then randomly modified in certain ways. Interrupting signals may be pre-recorded and possibly modified by duration, frequency, etc. Other qualities may be varied. Since people may respond differently to different interruptions, the type of interruption selected, and possibly the description of the quality of the interruption, may affect the choice of the detection method used for determining if the speaker is reacting to the interruption in a way a human speaker would.

The engine or process which reviews or analyzes the user's speaking during the interrupting signal and determines if, or the likelihood, that the person is real, may be for example caller observation engine 50, but may be another process or model. Various methods may be used to detect, based on speech, if the speaker is human, such as phonetic analysis, analysis of pauses or repeats, etc.

Reactions may vary across different categories or types of interruption or injection, and thus different analysis methods, or analysis engines, may be selected for each category of interruption. For example, noise may induce a live caller to produce Lombard-style speech, because the caller perceives him or herself as being in a noisy environment. This may create a shift upward in pitch, an increase in vocal effort, and a general shift in energy from lower frequencies to higher frequencies. Another style of interruption or audio injection is to send a loud impulsive noise, which may change the time-domain characteristics of the caller, as they pause to allow the interruption to complete, and possibly re-start the current word or phrase.

In one embodiment a machine learning trained process, such as a neural network, may be used. For example a long short-term memory (LSTM) recurrent neural network (RNN) may be suitable for processing data as described herein. A machine learning process may be trained with a large set of recordings of users speaking while not hearing any interruption, and also with a large set of recordings of users speaking while hearing an interruption. The process being trained. e.g. a neural network, may thus learn to distinguish interrupted speech from non-interrupted speech. The recordings of un-interrupted human speech may be considered for the purposes of training to be the equivalent of recordings or artificial speech used for attempted spoofing, since a recording of a human speaking a passphrase, or computer-generated speech, typically will not include a reaction to an interrupting signal, or will not include the proper reaction. Thus the process being trained may be trained to detect as “not a live human” the recordings of un-interrupted speech. Further, typically the occurrence of fraud (e.g. recorded speech, or a TTS process) among the samples of interrupted speech are so small, typically well under 1%, that these samples will not corrupt the training. While different people may have different reactions to a specific interruption, machine learning may be able to detect the broad range of reactions, when compared to speech with no such reaction. Positive “human” samples can be collected by “turning on” an audio injection engine and providing audio interruptions, and recording the input that will later be provided to a caller observation engine. Real users of the call center can be used to collect data, given the assumption that for example 99.99% of callers are not using playback or synthetic speech. “Non-human” samples may be considered recordings of what is occurs when no interrupting audio is injected, which assumes that the playback or synthetic speech is indistinguishable from the true account-holder's speech. Further, in some embodiments, different engines or neural networks may be trained for each category or type of interruption, as the reactions among these types may be sufficiently different.

A process trained using machine learning may thus detect a user's reaction to a prompt, without the designer of the system specifying the details of the reaction. In one embodiment, each of a set of different interruption signals sent (e.g. tone, beep, line static, background noise) may be used to train a different process (e.g. neural network), since the reaction to each may be different. Thus, in some embodiments, a set of different machine recognition processes may be created and used, and the specific signal sent to the speaker may be used to select which machine recognition process is used to determine if the caller is real or not. For example, caller observation engine 50 may take as input the type or category of interruption (beep, static, etc.), and/or information such as when and what type of effects to look for, and use one of a number of available trained neural networks or other processes to determine if the recorded spoken response is that of a real person.

Different features of responses or voice streams of responses may be detected to determine if they are interrupted response: for example phonetic analysis, time domain issues, such as pauses and stutters, etc. Analyzing phonetic content may involve translating the audio recording of the input speech into a phoneme string using known methods (e.g. using known acoustic decoding methods, such as Hidden Markov Model (HMM) system, or Hybrid Deep Neural Network (DNN)-HMM system), and determining if certain phonemes or series of phonemes are repeated, interrupted, or paused, which may indicate a live human response to an interruption. Different methods may be used to detect these features. A phonetic decoder may be run, in order to detect repeats or other disfluencies. Another method according to one embodiment uses a processing engine, typically a machine-learning trained neural network (e.g. learning-trained process 52). A deep learning process may take any data and analyze it without regard to specific algorithms or techniques that may be used in other methods to analyze the data. In one embodiment, a learning trained process may be both trained and used (e.g. at run-time) with vectors (e.g. ordered lists of quantities) of features. A recording or voice stream of a subject responding to a prompt or speaking a phrase may be represented by multiple vectors, each representing a time stamp or a sample at a certain time. Each item in a vector may represent a different feature, and there may be for example 200-300 features represented in each vector (other numbers may be used). A typical duration of a subject responding may be for example 1-4 seconds, but other durations may be used. In some embodiments, vectors may be generated or extracted every 100^{th} of a second, but other intervals may be used. While different features may be sampled at different intervals as needed, for simplicity all features may be extracted at the same interval. Other input for training and/or run-time usage may include time shifts inherent in telephony, specific to the application being trained for. Features represented may include for example, energy, a number of specific phonemes (e.g. different features for representations of a, p, etc.), delta energy, vocal cord vibration rate, and/or other standard acoustic or speech measurements. The model created is typically an engine or process which estimates whether or not a stutter, pause or other dysfluency occurred at the time that correlates correctly with when the interfering signal was sent down the line to the “speaker”, possibly allowing for time shifts inherent in telephony. The deep learning system may recognize that spectral domain repeats, when occurring at the known time of the interference, are indicative of an actual human speaker, rather than a playback that is unaffected by the injected signal.

Typical time shifts resulting from telephony are between 50 and 700 milliseconds, and typically it is not practical to estimate a specific time shift for each call, in part because calls can be spoofed such that a call purporting to come from a nearby location may be coming from a different continent. Thus a standard telephony delay may be used for all calls in a certain application or embodiment. In some embodiments the algorithm detecting disfluencies does not need to be told of the telephony delay used at training time or running time, because if a machine learning algorithm is used the telephony delay is simply part of the pattern matching: thus in some embodiments telephony delay need not be used or considered.

Embodiments of the invention may improve the technology of person authentication, and voice authentication. Prior methods of determining if a speaker is in fact a live human as opposed to a machine or recording rely on passive methods. Prior methods are based on a passive processing of audio, or different methods of phone validations. Both styles of prior systems can only be effective on certain calls. Embodiments of the present invention can be used on every call. Embodiments of the present invention include a new process relying on active methods, and are more efficient and accurate.

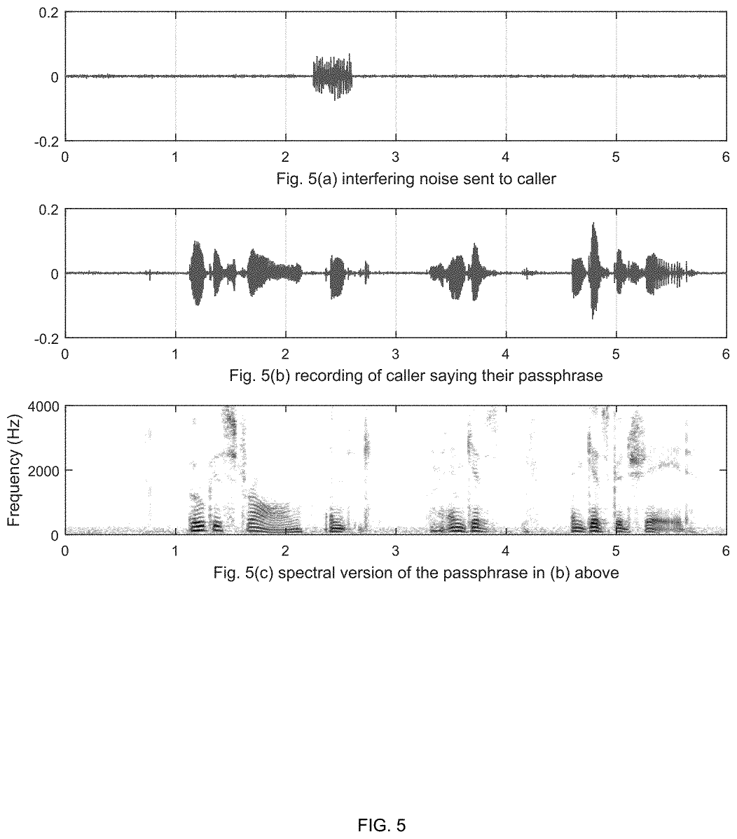

FIGS. 5A-5C are graphs showing the results of an example use of a method according to embodiments of the present invention, in particular an impulsive-noise version of the audio injection or interruption. A test subject was asked to say the passphrase or response “Oak is strong and gives good shade” into a headset microphone. FIG. 5A shows a burst of white noise played into the headphones of the person, according to one example, with the X axis representing time and the Y axis representing amplitude. FIG. 5B shows the time-series or time-domain signal of the subject's speech, according to one example, with the X axis representing time and the Y axis representing amplitude. The subject says “Oak is strong” (ending at approximately 2.1 seconds) and the interfering signal starts as the subject is starting to say “and”. Noticeable is the stutter in the time domain (at 2.7-2.8 seconds), and later in the frequency domain can be seen that the phonetic content of “and” is repeated. This disfluency, around 3.3-3.7 seconds, is the result of the subject stopping speech to listen to the interruption, and then continue once it disappears. FIG. 5C a spectral or time-frequency domain version of the altered or interrupted passphrase, an altered version of FIG. 5B, according to one example, with the X axis representing time and the Y axis representing frequency.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the foregoing detailed description, numerous specific details are set forth in order to provide an understanding of the invention. However, it will be understood by those skilled in the art that the invention can be practiced without these specific details. In other instances, well-known methods, procedures, and components, modules, units and/or circuits have not been described in detail so as not to obscure the invention. Some features or elements described with respect to one embodiment can be combined with features or elements described with respect to other embodiments.

Although embodiments of the invention are not limited in this regard, discussions utilizing terms such as, for example, “processing,” “computing,” “calculating,” “determining,” “establishing”, “analyzing”, “checking”, or the like, can refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that can store instructions to perform operations and/or processes.

Although embodiments of the invention are not limited in this regard, the terms “plurality” and “a plurality” as used herein can include, for example, “multiple” or “two or more”. The terms “plurality” or “a plurality” can be used throughout the specification to describe two or more components, devices, elements, units, parameters, or the like. The term set when used herein can include one or more items. Unless explicitly stated, the method embodiments described herein are not constrained to a particular order or sequence. Additionally, some of the described method embodiments or elements thereof can occur or be performed simultaneously, at the same point in time, or concurrently.

What is claimed is:

1. A method of voice authentication of an audio stream represented to be the spoken voice of a person, comprising:
receiving via a device a voice stream represented to be that of a person speaking:
providing an interfering audio signal to the device; and
using information regarding the interfering audio signal, determining if the voice stream indicates a reaction to the audio output.

2. The method of claim 1, comprising:
if the voice stream indicates a reaction to the interfering audio signal, determining that the audio stream is an audio stream of a person speaking live; and
if the voice stream does not indicate a reaction to the interfering audio signal, determining that the audio stream is not a person speaking live.

3. The method of claim 1, comprising:
if the voice stream indicates a reaction to the interfering audio signal, then:
determining that the audio stream is an audio stream of a person speaking live; and
authenticating the person.

4. The method of claim 1, wherein the interfering audio signal is provided at a first time during the voice stream, and wherein determining if the voice stream indicates a reaction to the audio output comprises relating to the first time during the voice stream, one of: a pause, a disfluency, or a repeat occurs.

5. The method of claim 1, wherein the interfering audio signal is provided at a time during the voice stream, and wherein determining if the voice stream indicates a reaction to the audio output comprises providing the voice stream and the time to a system trained by deep learning using samples of voice streams.

6. The method of claim 1, wherein the interfering audio signal is selected from the group consisting of a beep, a tone, a simulation of telephony line noise, and static.

7. The method of claim 1, wherein determining if the voice stream indicates a reaction to the audio output comprises providing to a trained process a vector, each element of the vector describing a feature of the voice stream.

8. The method of claim 1, wherein the reaction is a raise in the volume of voice or a dysfluency.

9. A method for determining if a speaker is a human speaking live, comprising:
receiving a stream comprising audio of a voice;
transmitting interruption audio during the receipt of the stream; and
analyzing the stream to determine whether or not the audio of the voice includes a reaction to the interruption audio.

10. The method of claim 9, comprising:
if the voice includes a reaction, determining that the stream is of a person speaking contemporaneously; and
if the voice does not include a reaction, determining that the stream is not a person speaking contemporaneously.

11. The method of claim 9, comprising, based on the voice including a reaction, determining a likelihood that the stream is of a person speaking contemporaneously.

12. The method of claim 9, comprising:
if the voice includes a reaction, determining that the stream is a stream of a person speaking contemporaneously; and
authenticating the person.

13. The method of claim 9, wherein the interruption audio is transmitted at a time during the stream, and wherein determining if the audio of the voice includes a reaction comprises providing the stream and the time to a system trained by deep learning using samples of voice streams.

14. The method of claim 9, comprising randomly selecting the interruption audio from the group consisting of a beep, a tone, a simulation of telephony line noise, and static.

15. A system for voice authentication of an audio stream represented to be the spoken voice of a person, comprising:
a memory and;
a processor configured to:
receive via a device a voice stream represented to be that of a person speaking;
provide an interfering audio signal to the device; and
use information regarding the interfering audio signal to determine if the voice stream indicates a reaction to the audio output.

16. The system of claim 15, wherein the processor is configured to:
if the voice stream indicates a reaction to the interfering audio signal, determine that the audio stream is an audio stream of a person speaking live; and
if the voice stream does not indicate a reaction to the interfering audio signal, determine that the audio stream is not a person speaking live.

17. The system of claim 15, wherein the processor is configured to:
if the voice stream indicates a reaction to the interfering audio signal, then:
determine that the audio stream is an audio stream of a person speaking live; and authenticate the person.

18. The system of claim 15, wherein the interfering audio signal is provided at a first time during the voice stream, and wherein determining if the voice stream indicates a reaction to the audio output comprises relating to the first time during the voice stream, one of: a pause, a disfluency, or a repeat occurs.

19. The system of claim 15, wherein the interfering audio signal is provided at a time during the voice stream, and wherein determining if the voice stream indicates a reaction to the audio output comprises providing the voice stream and the time to a system trained by deep learning using samples of voice streams.

20. The system of claim 15, wherein determining if the voice stream indicates a reaction to the audio output comprises providing to a trained process a vector, each element of the vector describing a feature of the voice stream.
